(19) United States
(12) Patent Application Publication
(10) Pub. No.: US 2009/0053468 A1
(43) Pub. Date: Feb. 26, 2009

(54) OPTICAL FILM AND METHOD FOR MAKING THE SAME

(75) Inventors: Chin-Wei LU, Taoyuan Hsien (TW); Chiao-Ning HUANG, Taoyuan Hsien (TW)

Correspondence Address: FOLEY AND LARDNER LLP;SUITE 500, 3000 K STREET NW, WASHINGTON, DC, 20007, US

(73) Assignee: FAR EASTERN TEXTILE LTD.

(21) Appl. No.: 12/049,479

(22) Filed: Mar. 17, 2008

(30) Foreign Application Priority Data
Aug. 22, 2007 (TW) 096131075

(51) Int. Cl. D06N 7/04; B05D 3/10

(52) U.S. Cl. 428/142; 427/307; 427/308

(57) ABSTRACT

An optical film includes: a transparent substrate having a roughened surface with an average surface roughness Ra ranging from 40 nm to 120 nm; and an optical functional layer attached to the roughened surface of the transparent substrate. A method for making an optical film includes: (a) providing a transparent substrate having a surface; (b) roughening the surface of the transparent substrate such that the roughened surface has an average surface roughness Ra ranging from 40 nm to 120 nm; and (c) forming an optical functional layer on the roughened surface of the transparent substrate.

### CROSS-REFERENCE TO RELATED APPLICATION

This application claims priority of Taiwanese application no. 096131075, filed on Aug. 22, 2007.

### BACKGROUND OF THE INVENTION

1. Field of the Invention

This invention relates to an optical film and a method for making the same, more particularly to an optical film with a roughened surface and a method for making the same.

2. Description of the Related Art

A display is usually provided with an optical film on a screen thereof so as to improve display quality. The optical film usually includes a transparent substrate and an optical functional layer containing at least one of an optical sub-layer, e.g., a hard coating, an anti-static sub-layer, an anti-glare sub-layer, or an anti-reflective sub-layer.

However, when light passes through media with different refractive indexes, a reflected light occurs at an interface between the media. When the optical functional layer is greater than 1 μm, an interference phenomenon is likely to occur due to optical path differences in reflected lights that occur at different interfaces. For example, as shown in FIG. 1, when incident light 2 passes through an optical functional layer 12, a first reflected light 21 occurs at an interface 121 between air and the optical functional layer 12, and a second reflected light 22 occurs at an interface 111 between the optical functional layer 12 and a transparent substrate 11. The first and second reflected lights 21, 22 travel at substantially the same direction. Since the thickness of the optical functional layer 12 is several times the wavelength of visible light (400˜700 nm), interference stripes occur due to the optical path difference between the first and second reflected lights 21, 22, thereby reducing image quality of the display.

The interference phenomenon of an optical film can be improved by decreasing the difference in the refractive index between the optical functional layer and the transparent substrate. However, a decrease in the difference in the refractive index will result in the loss of the anti-reflection property provided by a low refractive layer that is subsequently applied.

In addition, Taiwanese Publication No. 200626368 discloses an optical laminate including a light transmissible substrate, an anti-static layer, and a hard coating layer. The technical feature of the Taiwanese publication resides in that the hard coating layer is made from a composition containing a resin and a permeating solvent. The permeating solvent penetrates into the anti-static layer and the light transmissible substrate. By virtue of penetration of the permeating solvent, an anti-static agent contained in the anti-static layer is dispersed into the anti-static layer and the light transmissible substrate, thereby substantially eliminating the interface between the anti-static layer and the light transmissible substrate and thus reducing the interference phenomenon. However, penetration of the permeating solvent into the anti-static layer and the light transmissible substrate is difficult to control, the materials used for the anti-static layer, the hard coating layer and the permeating solvent have to be carefully chosen to match with each other, thereby limiting the materials suitable for the anti-static layer and the hard coating layer.

Therefore, there is a need in the art to provide an optical film having minimum interference phenomenon.

### SUMMARY OF THE INVENTION

Therefore, the object of the present invention is to provide an optical film and a method for making the same that can overcome the aforesaid drawbacks of the prior art.

According to one aspect of this invention, an optical film includes: a transparent substrate having a roughened surface with an average surface roughness Ra ranging from 40 nm to 120 nm; and an optical functional layer attached to the roughened surface of the transparent substrate.

According to another aspect of this invention, a method for making an optical film includes: (a) providing a transparent substrate having a surface; (b) roughening the surface of the transparent substrate such that the roughened surface has an average surface roughness Ra ranging from 40 nm to 120 nm; and (c) forming an optical functional layer on the roughened surface of the transparent substrate.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic view of a conventional optical film illustrating reflection paths of incident light and reflected light;

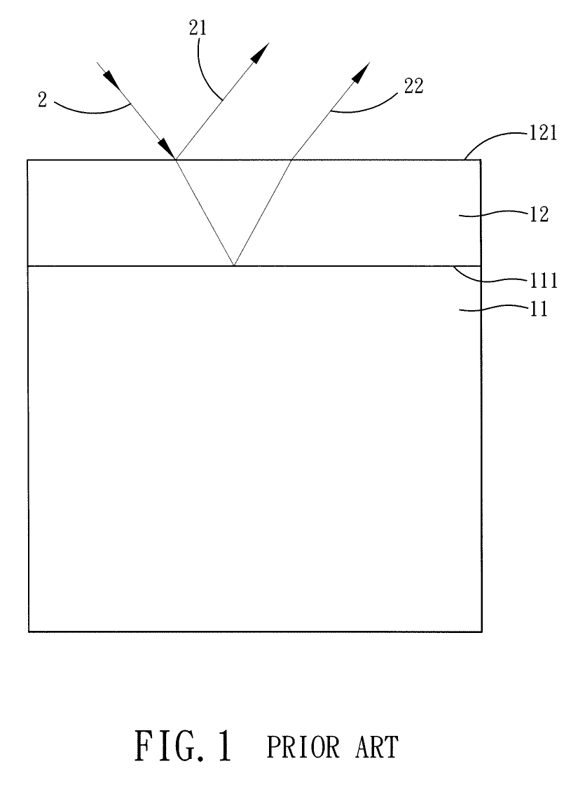

FIG. 2 is a plot showing reflection spectra of optical films of the examples of this invention and the comparative example; and

FIG. 3 is a schematic view of the preferred embodiment of an optical film according to this invention, illustrating reflection paths of incident light and reflected light.

### DETAILED DESCRIPTION OF THE PREFERRED EMBODIMENTS

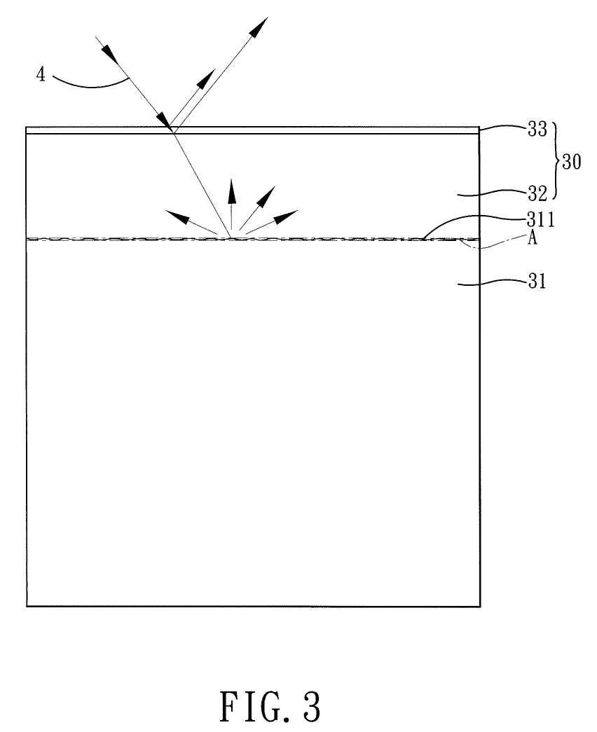

Referring to FIG. 3, the preferred embodiment of an optical film according to the present invention is shown to include a film body. The film body includes a transparent substrate 31 having a roughened surface 311 with an average surface roughness Ra ranging from 40 nm to 120 nm; and an optical functional layer attached to the roughened surface 311 of the transparent substrate 31.

The average surface roughness Ra should be controlled to be within 40 nm to 120 nm. If the average surface roughness Ra is less than 40 nm, the effect of eliminating interference phenomenon becomes poor. If the average surface roughness Ra is greater than 120 nm, the haze value of the film body of the optical film increases. When the haze value is greater than 1.5%, the application of the optical film becomes limited. Preferably, the haze value of the film body ranges from 0.6 to 1.5%.

The roughened surface 311 defines a buffer region (A) having a refractive index gradually changing from an interface between the optical functional layer and the buffer region (A) to an interface between the buffer region (A) and the transparent substrate 31 (see FIG. 3).

Preferably, the transparent substrate 31 is made from a flexible plastic material, e.g., triacetyl cellulose (TAC), polyethylene terephthalate (PET), or polycarbonate (PC).

The optical functional layer can have a single layer structure or a multiple-layer structure based on actual requirements. Preferably, the optical functional layer includes a plurality of sub-layers to meet multi-function requirements. For example, as shown in FIG. 3, the optical functional layer includes an anti-static sub-layer 32 formed on the transparent substrate 31, and an anti-reflective sub-layer 33 formed on the anti-static sub-layer 32. The anti-static sub-layer 32 provides anti-static property and scratch resistance, and the thickness thereof should be at μm order. The anti-reflective sub-layer 33 has a refractive index smaller than that of the anti-static sub-layer 32, and the thickness thereof is about 100 nm.

The preferred embodiment of a method for making the optical film according to the present invention includes: (a) providing a transparent substrate 31 having a surface 311; (b) roughening the surface 311 of the transparent substrate 31 such that the roughened surface 311 has an average surface roughness Ra ranging from 40 nm to 120 nm; and (c) forming an optical functional layer on the roughened surface 311 of the transparent substrate 31.

Preferably, the roughening step (b) is conducted by applying a solvent capable of dissolving the transparent substrate 31 on the surface 311 of the transparent substrate 31 such that the surface 311 of the transparent substrate 31 is etched by the solvent. Examples of the solvent capable of dissolving the transparent substrate 31, e.g., triacetyl cellulose, polyethylene terephthalate, or polycarbonate, include ketones (e.g., methyl ethyl ketone, acetone, cyclopentanone, etc.), esters (e.g., methyl acetate, ethylacetate, etc.), alkalides (e.g., chloroform, methylene chloride, etc.), 1,4-dioxane, and diacetone alcohol. Application of the solvent can be conducted through wire rod coating, spin coating, or dip coating.

Preferably, the roughening step can be modified by baking the transparent substrate 31 after applying the solvent on the transparent substrate 31. In addition, the surface roughness can be controlled by adjusting the thickness of the applied solvent film, drying conditions of the applied solvent film, and the kind of the solvent.

The step (c) of forming the optical functional layer is conducted by applying functional coating materials (e.g., anti-static coating material, scratch resistant coating material, low refractive coating material, anti-glare coating material, etc.) on the roughened surface 311, followed by curing the functional coating materials.

### EXAMPLES

### Example 1

A cyclopentanone solvent (ACROS) was applied on a TAC substrate (Konica Minolta, 8UYSMW, having an A4 size and 80 μm thickness) using a wire rod coating method so as to form a solvent film with 20 μm thickness on the TAC substrate. The substrate applied with the solvent film was baked in an oven at 40° C. for 3 minutes, and then at 100° C. for 5 minutes so as to form a roughened surface having an average surface roughness (Ra) of 105 nm (measured by Kosaka Laboratory Ltd., ET4000A). An anti-static/scratch resistant material (Pelnox Ltd., C-4010, refractive index 1.61, 10 μm thickness) was applied on the roughened surface of the substrate, and was subsequently dried and cured using UV light so as to form an anti-static sub-layer (having 5 μm thickness) on the substrate. A low refractive material (JSR Corporation, TU 2164, refractive index 1.38, 5 μm thickness) was applied on the anti-static sub-layer, and was subsequently dried and cured using UV light so as to form an anti-refractive sub-layer having a thickness of 95 nm. Therefore, an optical film was obtained.

### Example 2

A cyclopentanone solvent (ACROS) was applied on a TAC substrate (Konica Minolta, 8UYSMW, having an A4 size and 80 μm thickness) using a wire rod coating method so as to form a solvent film with 20 μm thickness. The substrate applied with the solvent film was baked in an oven at 100° C. for 5 minutes so as to form a roughened surface having an average surface roughness (Ra) of 47 nm. An anti-static/scratch resistant material (Pelnox Ltd., C-4010, refractive index 1.61, 10 μm thickness) was applied on the roughened surface of the substrate, and was subsequently dried and cured using UV light so as to form an anti-static sub-layer (having 5 μm thickness) on the substrate. A low refractive material (JSR Corporation, TU2164, refractive index 1.38, 5 μm thickness) was applied on the anti-static sub-layer, and was subsequently dried and cured using UV light so as to form an anti-refractive sub-layer having a thickness of 95 nm. Therefore, an optical film was obtained.

### Comparative Example

A TAC substrate (Konica Minolta, 8UYSMW, having an A4 size, 80 μm thickness, and an average surface roughness of 8 nm) was coated with an anti-static/scratch resistant material (Pelnox Ltd., C-4010, refractive index 1.61, coating thickness: 10 μm), and was subsequently dried and cured using UV light so as to form an anti-static sub-layer (having 5 μm thickness) on the substrate. A low refractive material (JSR Corporation, TU 2164, refractive index 1.38, 5 μm thickness) was applied on the anti-static sub-layer, and was subsequently dried and cured using UV light so as to form an anti-refractive sub-layer having a thickness of 95 nm. Therefore, an optical film was obtained.

### Reflection Spectra in Visible Light Range

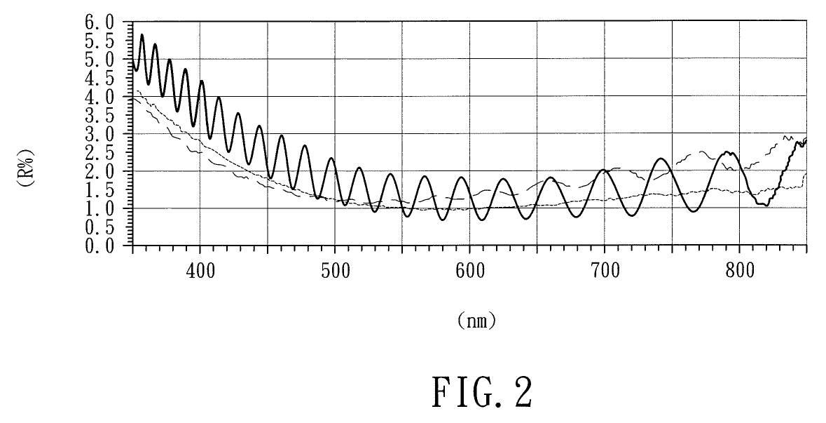

Reflection spectra for the optical films of Examples 1 and 2 and the comparative example were measured using a visible light/UV light spectrometer (Hitachi U4100). In FIG. 2, short dashed line is the spectrum for the optical film of Example 1, long dashed line is the spectrum for the optical film of Example 2, and the continuous line is the spectrum for the optical film of the comparative example. Large amplitudes of vibration of the spectrum indicates ease of occurrence of the interference stripes. As shown in FIG. 2 and Table 1, the roughened surface with Ra ranging from 40 to 120 nm (i.e., Examples 1 and 2) is effective in eliminating the interference phenomenon, i.e., has minimal interference phenomenon. In addition, Example 1 having a greater Ra value (105 nm) exhibits a better effect on elimination of the interference phenomenon than Example 2 having a smaller Ra value (47 nm). As shown in FIG. 3, when an incident light 4 passes through the optical functional layer and reaches the roughened surface 311 of the transparent substrate 31, it is scattered by the roughened surface 311, which results in elimination of the interference phenomenon as encountered in the aforesaid conventional optical film.

TABLE 1

| | | | Effect on |
|---|---|---|---|
| | | | elimination |
| | | | of |
| | | Haze | interference |
| | Ra (nm) | value (%) | stripes |
| Example 1 | 105 | 1.20. | The best |
| Example 2 | 47 | 0.64 | good |
| Comparative | 8 | 0.33 | The worst |
| Example | | | |

According to the present invention, with the formation of the roughened surface of the transparent substrate, the interference phenomenon can be effectively eliminated.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. An optical film comprising a film body including:
a transparent substrate having a roughened surface with an average surface roughness Ra ranging from 40 nm to 120 nm; and
an optical functional layer attached to said roughened surface of said transparent substrate.

2. The optical film of claim 1, wherein said film body has a haze value ranging from 0.6 to 1.5%.

3. The optical film of claim 2, wherein said roughened surface defines a buffer region having a refractive index gradually changing from an interface between said optical functional layer and said buffer region to an interface between said buffer region and said transparent substrate.

4. The optical film of claim 3, wherein said transparent substrate is made from a flexible plastic material.

5. The optical film of claim 4, wherein said flexible plastic material is selected from the group consisting of triacetyl cellulose, polyethylene terephthalate, and polycarbonate.

6. The optical film of claim 3, wherein said optical functional layer includes an anti-static sub-layer formed on said roughened surface of said transparent substrate, and an anti-reflective sub-layer formed on said anti-static sub-layer.

7. A method for making an optical film, comprising:
(a) providing a transparent substrate having a surface;
(b) roughening the surface of the transparent substrate such that the roughened surface has an average surface roughness Ra ranging from 40 nm to 120 nm; and
(c) forming an optical functional layer on the roughened surface of the transparent substrate.

8. The method of claim 7, wherein the roughening step is conducted by applying a solvent capable of dissolving the transparent substrate on the surface of the transparent substrate such that the surface of the transparent substrate is etched by the solvent.

9. The method of claim 7, wherein the transparent substrate is made from a material selected from the group consisting of triacetyl cellulose, polyethylene terephthalate, and polycarbonate.

10. The method of claim 8, wherein the solvent is selected from the group consisting of methyl ethyl ketone, acetone, cyclopentanone, methyl acetate, ethyl acetate, chloroform, methylene chloride, 1,4-dioxane, and diacetone alcohol.
